(19) United States
(12) Patent Application Publication
(10) Pub. No.: US 2023/0313383 A1
(43) Pub. Date: Oct. 5, 2023

(54) METHOD FOR ELECTROLESSLY DEPOSITING A METAL LAYER ONTO A SUBSTRATE

(71) Applicant: PAC TECH - PACKAGING TECHNOLOGIES GMBH, Nauen (DE)

(72) Inventors: Vinith Bejugam, San Jose, CA (US); Thorsten Teutsch, Berlin (DE)

(21) Appl. No.: 18/024,550

(22) PCT Filed: Aug. 23, 2021
(86) PCT No.: PCT/EP2021/073250

§ 371 Date: Mar. 3, 2023

(30) Foreign Application Priority Data
Sep. 10, 2020 (DE) 10 2020 123 633.6

(51) Int. Cl. C23C 18/18; C23C 18/30; C23C 18/20; C23C 18/40

(52) U.S. Cl. CPC C23C 18/1893; C23C 18/2086; C23C 18/30; C23C 18/40

(57) ABSTRACT

A method for electrolessly depositing a metal layer onto a substrate, including the following chronological steps:
a) treating the substrate surface to be plated with an etching solution;
b) treating the substrate surface to be plated with a polyelectrolyte or an organosilane compound;
c) treating the surface to be plated with a solution containing metal particles;
d) treating the surface to be plated with a solution containing at least one salt of the metal to be deposited onto the substrate.

This application represents the national stage entry of PCT International Pat. Application No. PCT/EP2021/073250 filed on Aug. 23, 2021 and claims priority to German Pat. Application No. 10 2020 123 633.6 filed Sep. 10, 2020. The contents of each of these applications are hereby incorporated by reference as if set forth in their entirety herein.

The disclosure relates to a method for electrolessly depositing a metal layer onto a substrate in order to provide an economical method by means of which a very thin metal layer can be deposited onto a substrate without a vacuum.

From the state of the art, many methods are known for providing substrates with a metal layer. In this context, electroless methods and methods using electroplating offer economical solutions while other methods, such as those which work with a vacuum or steam, are significantly more costly in most instances.

With known wet chemical methods, a surface to be plated is commonly subjected to a cleaning pre-treatment first. Subsequently, the surface to be plated is often activated with tin or palladium particles. A palladium-based activation has taken place in the industry since the 1950s. After the activation, the surface is treated with a metal salt solution in the known methods, the metal salt solution being reduced onto the surface. A galvanic plating technique is used if thicker metal layers are desired. In contrast, an electroless plating technique is used, in particular in the area of semiconductor technology, in order to obtain very thin metal layers with fairly little effort.

One of the challenges of the methods mentioned above has been and remains to provide sufficient adhesion of what is known as the metal seed layer. The most common method used to achieve this is to subject the surface to an etching process. This is carried out, in particular for surfaces made of glass, in order to achieve a mechanical interconnection of the activation reagents on the substrate surface. Roughening a glass surface by means of an etching process, however, is not ideal, in particular for high-frequency applications. Prior to metallization, polymers are also often subjected to a swelling and etching process as these processes are commonly used for repassivation methods and redistribution methods.

The object of the disclosure is to provide a method for electrolessly depositing a metal layer onto a substrate, by means of which an ultrathin and smooth metal layer can be deposited onto a substrate as inexpensively as possible, the metal layer being intended to adhere on the substrate as rigidly as possible.

According to the disclosure, this object is attained by a method having the features of claim 1.

After treating the substrate surface to be plated with an etching solution, the substrate surface to be plated is first treated with a polyelectrolyte or an organosilane compound. Subsequently, a treatment with metal particles, in particular gold, silver, copper and/or platinum particles, is carried out for activating the substrate surface. These metal particles are immobilized on the substrate by the previously applied polyelectrolyte and/or organosilane compound. This significantly enhances the adhesion of the activating metal particles on the substrate surface. With the subsequent treatment of the surface to be plated with a solution which contains a salt of the metal to be deposited onto the substrate, an ultrathin and smooth metal layer having a thickness of 50 nm to 1,000 nm can be inexpensively deposited on a substrate. As a general rule, the solution in step d) contains copper ions, such as copper sulfate. It has been discovered that particularly thin and smooth copper layers can be deposited onto substrates using the method according to the disclosure.

The substrate surface to be plated is preferably treated with a polyelectrolyte, selected from the group consisting of polydiallyldimethylammonium (PDDA), polyethyleneimine (PEI), polyacrylic acid (PAA), polystyrene sulfonate (PSS), polyethylene oxide (PEO) and polylysine, in step b). These polyelectrolytes have proven to be particularly effective for immobilizing metal particles, in particular gold, silver, copper and/or platinum particles.

For a particularly preferred variation of the method according to the disclosure, the solution in step d) contains at least one polysaccharide, preferably at a concentration of 0.05 % or less. It has proven that polysaccharides in the plating solution can modulate ionic interactions and the size of the deposited particles, whereby the adhesion of the metal layer to be deposited is improved. Moreover, it has been observed that a more uniform layer growth can be attained with polysaccharides when electrolessly depositing the metal layer. Moreover, it has proven that polysaccharides serve as stabilizers for the plating solution. It is presumed that the particle size of the metal to be deposited, in particular the size of copper particles, is reduced by polysaccharides. By using polysaccharides in the plating solution, it was further achieved that an etching of glass substrates could be reduced. A polysaccharide source can be agar agar, for example.

Advantageously, the above-mentioned gold, silver, copper and/or platinum particles in step c) are available as gold, silver, copper and/or platinum nanoparticles, the nanoparticles preferably having a diameter of approximately 5 nm to 100 nm and preferably having charged functional groups. With charged functional groups, particularly advantageous electrostatic ionic interactions between the nanoparticles and the previously deposited polyelectrolyte and/or the previously deposited organosilane compound are the result, whereby the nanoparticles are immobilized particularly stably on the surface of the substrate to be plated. Advantageously, step c) contains gold nanoparticles, in particular nanoparticles having gold chloride and citric acid, and preferably at least one surfactant, such as Triton-X®. Triton-X® is a surfactant based on polyethylene glycol. In particular, surfactants of this kind reduce the tendency of the particles to aggregate by a factor of 2. A steric hindrance stabilizes the nanoparticles, polyethylene glycol additionally improving wetting. Optionally, sodium citrate can be added to enhance stability.

Advantageously, the metal salt in step d) is present in the form of microparticles, in particular having a diameter of approximately 100 nm to 1,000 nm. In this manner, transition layers made of polyelectrolytes, nanoparticles and microparticles can be generated, with the aid of which ultrathin and extremely smooth metal layers can ultimately be generated.

The substrate can be made of polymer or based on silicon. Preferably, however, the substrate is made of glass, the substrate preferably being an interposer having through-holes. Glass interposers are used in particular in the semiconductor sector. In this context, glass interposers allow directly matching the thermal expansion coefficient with a silicon chip. Furthermore, interposers made of glass provide better electrical properties compared to silicon. Moreover, interposers of this kind are available in panel sizes and provide a high interconnect density. Metal seed layers on glass interposers moreover provide promising solutions for high-transmission and memory-bandwidth applications.

As a general rule, the substrate in step a) is treated with acid.

Preferably, prior to step b), a plastic substrate is treated with dimethyl sulfoxide (DMSO) or N-methyl-2-pyrrolidone (NMP) at approximately 25° C. to 60° C. and is subsequently treated with a swelling agent, such as DMSO, a surfactant based on polyethylene glycol, such as Triton-X®, ammonium hydroxide and/or sodium hydroxide and an alcohol, such as methanol, isopropanol or ethanol, . As a rule, a glass substrate is treated with at least one acid, such as nitric acid, sulfuric acid, piranha solution, hydrochloric acid or aqua regia, or with potassium bifluoride salts, sodium bifluoride salts and/or ammonium bifluoride salts.

In a further development of the method according to the disclosure, the plated substrate surface is galvanically plated after step d). By combining electroless plating and galvanic plating in this manner, a filling of through-holes in an interposer can be achieved. This combination allows attaining layer thicknesses of larger than 1 µm.

Advantageously, the substrate is rinsed with water, in particular distilled water, before and after every step, the substrate preferably being treated with water and acid after step d).

In a preferred variation of the method according to the disclosure, the solution from step d) further contains a reducing agent, in particular formaldehyde, hydrazine and/or glyoxylic acid. This reducing agent reduces the metal cations of the metal salt from step d) to elemental metal. As a result, an ultrathin metal layer having a thickness of 50 nm to 1,000 nm is obtained.

Should an organosilane compound be used as the immobilizing reagent in step b), it is preferably selected from the group consisting of alkenyl silanes, chloropropyl silanes, aminopropyl silanes, thiopropyl silanes and/or cyanoethyl silanes and/or ether silanes, ester silanes and/or epoxy-substituted alkyl silanes.

As a rule, the solution from step d) has a pH value of approximately 10 to 12.

Advantageously, the solution from step d) contains at least one complexing agent, such as EDTA, N, N, N′, N′-tetrakis(2-hydroxypropyl) ethylendiamine (quadrol) or potassium sodium tartrate.

As a rule, step b) is carried out at a temperature of 25° C. to 90° C.

The method according to the disclosure, by means of which a metal layer can be formed on a surface provided with noble metal particles, is also suitable for surface plasmon resonance (SPR) applications and for heat-sensitive photonic and optoelectronic applications. The size of the used nanoparticles, the plating rate, the pH value and the nanoparticle density affect the morphological and mechanical properties of the metal layer to be generated.

### EXAMPLES

### Example 1

Glass substrates were cleaned using acetone and piranha solution for one hour and then incubated in 10 % to 20 % PDDA solution for two hours. Subsequently, the samples were rinsed with distilled water and placed in a solution with gold nanoparticles which was produced according to the Turkevich method, wherein the particle size was < 100 nm. The solution contained 1 % of gold chloride, 0.01 % of Triton-X® and 0.3 g/l trisodium citrate. After the nanoparticles had been immobilized on the substrate for at least two hours, the samples were rinsed once more and placed in a plating bath having 0.05 % of agar agar, 3.2 g/l copper sulfate pentahydrate, 11.3 g/l potassium sodium tartrate, 5 g sodium hydroxide (pH value 10 to 12) and 32 ml/l formaldehyde. In this case, the agar agar was used as a polysaccharide source. By varying the plating times from 2 minutes to 20 minutes at room temperature, seed layers having a thickness of 30 µm to 150 µm were obtained. A tape test according to ASTM showed a 5B grade, indicating a strong adhesion.

### Example 2

Example 2 was carried out analogous to Example 1, with the exception that PDDA was replaced by 1 g/l branched polyethylene (molecular weight 25,000 to 750,000, PEI).

### Example 3

Example 3 was carried out analogous to Example 1, with the exception that PDDA was replaced by 0.946 g/l (3-aminopropyl)triethoxysilane or APTES.

### Example 4

Example 4 was carried out analogous to Example 1, with the exception that the glass substrates were replaced by photoreactive, cured polyimide or dry-layer epoxy substrates, which were deposited on a silicon or glass substrate. Additional swelling or etching treatments were integrated into the method as a part of the pre-treatment, before an incubation in PDDA/APTES was carried out. Swelling in an aprotic solvent, such as dimethyl sulfoxide (DMSO), was carried out at 25° C. to 60° C. for one minute. Subsequently, micro-etching took place in a solution containing 0.5 % to 1 % of a water-soluble swelling agent, such as DMSO, 0.5 % to 1 % of surfactants based on polyethylene glycol, such as Triton-X®, 1 % to 3 % of ammonium hydroxide compounds and/or sodium hydroxide compounds and 10 % to 30 % of alcoholic compounds, such as methanol, isopropanol or ethanol for 20 minutes to 1 hour. Subsequently, the substrates were treated with 10 % sulfuric acid before being rinsed and immersed in a polyelectrolyte solution.

1. A method for electrolessly depositing a metal layer onto a substrate, the method comprising the following chronological steps:
a) treating the substrate surface to be plated with an etching solution;
b) treating the substrate surface to be plated with a polyelectrolyte or an organosilane compound;
c) treating the surface to be plated with a solution containing metal particles;
d) treating the surface to be plated with a solution containing at least one salt of the metal to be deposited onto the substrate.

2. The method according to claim 1, wherein
the solution from step c) contains gold, silver, copper and/or platinum particles, in particular colloidal gold.

3. The method according to claim 1, wherein
the solution from step d) contains copper ions, such as copper sulfate.

4. The method according to claim 1, wherein
the substrate surface to be plated is treated with a polyelectrolyte selected from the group consisting of polydiallyldimethylammonium (PDDA), polyethyleneimine (PEI), polyacrylic acid (PAA), polystyrene sulfonate (PSS), polyethylene oxide (PEO) and polylysine, in step b).

5. The method according to claim 1, wherein
the solution from step d) contains at least one polysaccharide, preferably at a concentration of 0.05 % or less.

6. The method according to claim 2, wherein
the gold, silver, copper and/or platinum particles from step c) are present as gold, silver, copper and/or platinum nanoparticles, the nanoparticles preferably having a diameter of approximately 5 nm to 100 nm and preferably having charged functional groups.

7. The method according to claim 1, wherein
the solution from step c) contains gold nanoparticles, in particular nanoparticles having gold chloride and citric acid, and preferably at least one surfactant, such as Triton-X®.

8. The method according to claim 1, wherein
the metal salt from step d) is present in the form of microparticles, in particular having a diameter of approximately 100 nm to 1,000 nm.

9. The method according to claim 1, wherein
the substrate is made of glass, polymer or based on silicon, the substrate preferably being an interposer having through-holes.

10. The method according to claim 1, wherein
the substrate from step a) is treated with acid.

11. The method according to claim 1, wherein
prior to step b), a plastic substrate is treated with dimethyl sulfoxide (DMSO) or N-methyl-2-pyrrolidone (NMP) at approximately 25° C. to 60° C. and is subsequently treated with a swelling agent, such as DMSO, a surfactant based on polyethylene glycol, such as Triton-X®, ammonium hydroxide and/or sodium hydroxide and an alcohol, such as methanol, isopropanol or ethanol; or a glass substrate is treated with at least one acid, such as nitric acid, sulfuric acid, piranha solution, hydrochloric acid or aqua regia, or with potassium bifluoride salts, sodium bifluoride salts and/or ammonium bifluoride salts.

12. The method according to claim 1, wherein
the plated substrate surface is galvanically plated after step d).

13. The method according to claim 1, wherein
the substrate is treated with water, in particular distilled water, before and after every step, the substrate preferably being treated with water and acid after step d).

14. The method according to claim 1, wherein
the solution from step d) further contains a reducing agent, in particular formaldehyde, hydrazine and/or glyoxylic acid.

15. The method according to claim 1, wherein
alkenyl silanes, chloropropyl silanes, aminopropyl silanes, thiopropyl silanes and/or cyanoethyl silanes and/or ether silanes, ester silanes and/or epoxy-substituted alkyl silanes are used as an organosilane compound.

16. The method according to claim 1, wherein
the solution from step d) has a pH value of approximately 10 to 12.

17. The method according to claim 1, wherein
the solution from step d) contains at least one complexing agent, such as EDTA, N, N, N′, N′-tetrakis(2-hydroxypropyl) ethylendiamine (quadrol) or potassium sodium tartrate.

18. The method according to claim 1, wherein
step b) is carried out at a temperature of 25° C. to 90° C.
